(19) United States
(12) Patent Application Publication
(10) Pub. No.: US 2020/0198053 A1
(43) Pub. Date: Jun. 25, 2020

(54) LASER PROCESSING HEAD, OPTICAL FIBER INSPECTION DEVICE, AND OPTICAL FIBER INSPECTION METHOD

(71) Applicant: Panasonic Intellectual Property Management Co., Ltd., Osaka (JP)

(72) Inventors: KIYOTAKA EIZUMI, Osaka (JP); TAKAYUKI YAMASHITA, Osaka (JP); DOUKEI NAGAYASU, Hyogo (JP); KENJI HOSHINO, Hyogo (JP); HIDEAKI YAMAGUCHI, Osaka (JP); NAOYA KATO, Osaka (JP); RYO ISHIKAWA, Osaka (JP); SHINYA DOMOTO, Osaka (JP)

(21) Appl. No.: 16/806,343

(22) Filed: Mar. 2, 2020

Related U.S. Application Data
(63) Continuation of application No. PCT/JP2018/033350, filed on Sep. 10, 2018.

(30) Foreign Application Priority Data
Sep. 11, 2017 (JP) 2017-174075

(51) Int. Cl. B23K 26/06; B23K 26/03; H01S 3/067

(52) U.S. Cl. CPC B23K 26/0643; H01S 3/06708; B23K 26/03; B23K 26/0648

(57) ABSTRACT

Laser processing head (20) includes collimator lens (23) that converts laser light (70) into a parallel light beam; light-collecting lens (24) that collects laser light (70) converted into the parallel light beam; case (21) that contains collimator lens (23) and light-collecting lens (24); wavelength selection mirror (25) that is provided between collimator lens (23) and light-collecting lens (24) and transmits laser light (70) while reflecting light of a given wavelength different from that of laser light (70); and a transmission window provided at a position where the light of the given wavelength is transmitted and also where laser emission end face (61) of optical fiber (60) can be optically observed through wavelength selection mirror (25).

This application is a continuation of the PCT International Application No. PCT/JP2018/033350 filed on Sep. 10, 2018, which claims the benefit of foreign priority of Japanese patent application No. 2017-174075 filed on Sep. 11, 2017, the contents all of which are incorporated herein by reference.

### TECHNICAL FIELD

The present disclosure relates to a laser processing head, an optical fiber inspection device that inspects an optical fiber connected to the laser processing head, and an optical fiber inspection method by which an optical fiber connected to the laser processing head is inspected.

### BACKGROUND

There has been known a laser processing device that wave-guides outgoing light from a laser (e.g., gas laser, solid laser) oscillator through an optical fiber, radiates the light from the laser processing head toward a workpiece to weld and to process the workpiece (refer to PTL 1 for example).

### CITATION LIST

### Patent Literature

PTL 1: Japanese Patent Unexamined Publication No. 2007-030032

### SUMMARY

### Problems to be Solved by the Invention

In an existing laser processing device, an optical fiber is connected to the laser processing head usually after the laser emission end face of the optical fiber is checked for dust or stain. This is because an undesired substance such as dust on the end face may be burned by laser light, damaging the end surface.

In the existing configuration described above, however, the end face cannot be checked after an optical fiber is connected to the laser processing head. For this reason, if an undesired substance such as dust attaches to the end face in the process of connecting the optical fiber to the laser processing head, the end face may be damaged in the subsequent laser processing.

In view of such a point, an object of the present disclosure is to provide a laser processing head that allows checking the laser emission end face of an optical fiber in a state where the optical fiber is connected to the end face, an optical fiber inspection device that inspects the optical fiber connected to the laser processing head, and an optical fiber inspection method by which the optical fiber connected to the laser processing head is inspected.

### Means to Solve the Problems

A laser processing head according to one aspect of the disclosure is one that is connected to an optical fiber and radiates laser light wave-guided through the optical fiber, toward an workpiece. The laser processing head includes a collimator lens that converts laser light to a parallel light beam; a light-collecting lens that collects the laser light converted to the parallel light beam; a case that contains the collimator lens and the light-collecting lens; a wavelength selection mirror that is placed in the optical path of the laser light between the collimator lens and the light-collecting lens, and transmits the laser light while reflecting light of a given wavelength different from that of the laser light; and a transmission window placed at a position where the light of the given wavelength is transmitted and also where the laser emission end face of the optical fiber can be optically observed through the wavelength selection mirror.

An optical fiber inspection device according to one aspect of the disclosure is one that inspects an optical fiber connected to the laser processing head described above. The optical fiber inspection device includes an illumination light source that illuminates the laser emission end face with light of a given wavelength different from that of the laser light, from the transmission window through the wavelength selection mirror; and an optical observation device that allows the laser emission end face illuminated by the illumination light source to be observed from the transmission window through the wavelength selection mirror.

An optical fiber inspection method according to one aspect of the disclosure is one by which an optical fiber connected to the laser processing head described above is inspected. The method includes a step of illuminating the laser emission end face with light of a given wavelength different from that of the laser light, from the transmission window through the wavelength selection mirror; a step of optically observing the end face illuminated with the light of the given wavelength different from that of the laser light, from the transmission window through the wavelength selection mirror; and a step of inspecting conditions of the end face based on the observation result in the step of observing.

### Advantage of the Invention

As described above, a laser processing head according to the disclosure is capable of inspecting the laser emission end face of an optical fiber in a state where the optical fiber is connected to the laser processing head. Furthermore, the end face can be observed without the need of detaching the optical fiber from the laser processing head, which allows the maintenance frequency of the laser processing head to be appropriately determined.

By an optical fiber inspection device and an optical fiber inspection method according to the disclosure, illumination light can be radiated onto the laser emission end face without the need of detaching an optical fiber from the laser processing head for observing conditions of the end face.

### BRIEF DESCRIPTION OF DRAWINGS

FIG. 1 illustrates the configuration of a laser processing device according to the first embodiment.

FIG. 2 illustrates the main part of a laser processing head to which an optical fiber and an optical fiber inspection device according to the first embodiment are attached.

FIG. 3 illustrates the main part of a laser processing head to which an optical fiber and an optical fiber inspection device according to the second embodiment are attached.

### DESCRIPTION OF EMBODIMENTS

Hereinafter, a detailed description is made of some embodiments of the present disclosure with reference to the related drawings. The following description of preferred embodiments is essentially for exemplification only and definitely is not intended to restrict the present disclosure, an object to which the disclosure is applied, or an application purpose of the disclosure.

### First Exemplary Embodiment

Configuration of Laser Processing Device

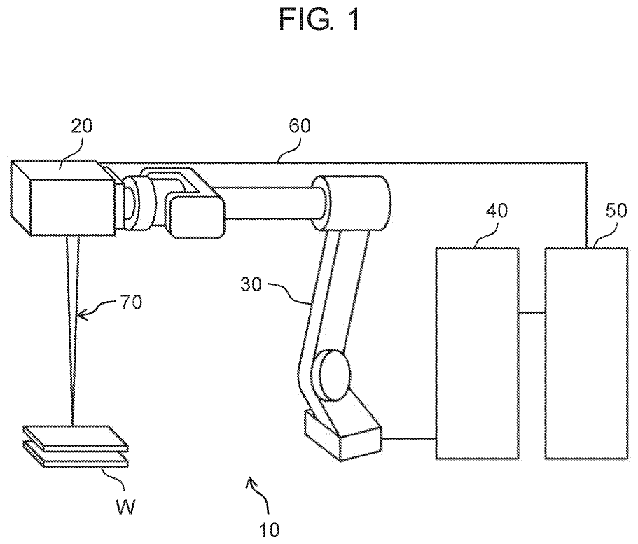

FIG. 1 illustrates the configuration of laser processing device 10 according to the embodiment. Laser processing device 10 includes laser processing head 20, manipulator 30, control unit 40, laser oscillator 50, and optical fiber 60.

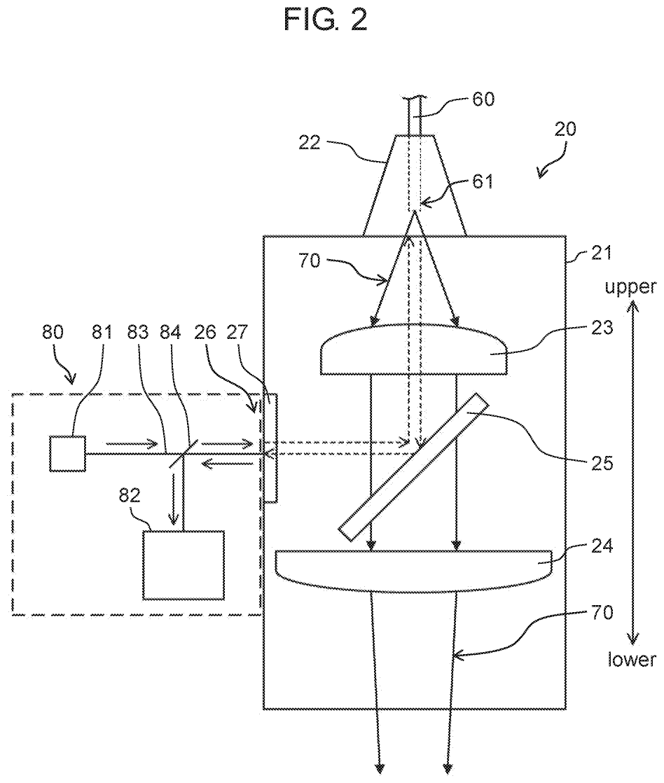

Laser processing head 20 radiates laser light 70 from optical fiber 60 toward workpiece W. Manipulator 30, to the tip of which laser processing head 20 is attached, moves laser processing head 20. Control unit 40 controls the operation of laser processing head 20, the operation of manipulator 30, and the laser oscillation of laser oscillator 50. Laser oscillator 50 oscillates laser light 70 and outputs it to optical fiber 60. Optical fiber 60 transmits laser light 70 output from laser oscillator 50, to laser processing head 20. With such a configuration, laser processing device 10 activates laser processing head 20 and manipulator 30 to radiate laser light 70 output from laser oscillator 50, toward workpiece W in a desired locus for cutting off, welding, and drilling workpiece W for example. For a regular inspection or other work, optical fiber inspection device 80 is attached to laser processing head 20 (refer to FIG. 2). Configuration of Main Part of Laser Processing Head

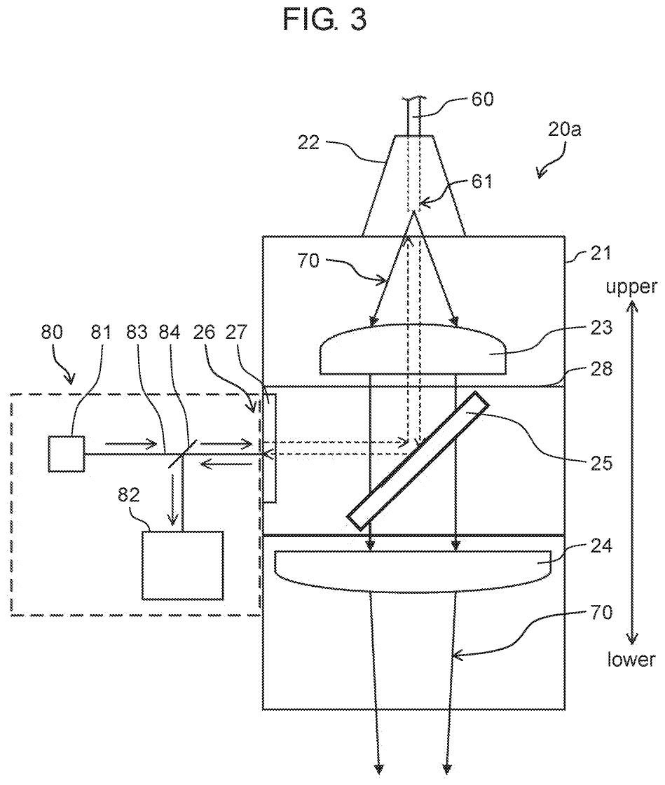

FIG. 2 illustrates the main part of laser processing head 20 to which optical fiber 60 and optical fiber inspection device 80 are attached. Note that the illustration and description of a component not directly related to the disclosure are omitted for convenience of description. In the following description, the part of laser processing head 20 where laser light 70 enters may be referred to as “upper”; the part where laser light 70 goes out from, as “lower.” Each broken-line arrow in FIGS. 2 and 3 schematically indicates the direction of a light beam and is not intended to show the center of an optical axis or the spread of light.

Laser processing head 20 includes case 21, connector 22, collimator lens 23, light-collecting lens 24, and wavelength selection mirror 25.

Case 21, to the topside of which connector 22 is attached, contains collimator lens 23, light-collecting lens 24, and wavelength selection mirror 25. There is transmission window 26 into which cover glass 27 is inserted, provided in the sidewall. There is a nozzle (unillustrated) for radiating laser light 70 toward workpiece W, provided at the lower part of light-collecting lens 24. As a result that optical components such as collimator lens 23 are retained inside case 21 while maintaining a given layout, the optical axis of laser light 70 emitted from laser processing head 20 is defined. Case 21 prevents dust and stain for example from attaching to optical components and stops laser light 70 from unintendedly leaking to the outside. Connector 22 connects and holds optical fiber 60 to laser processing head 20.

Collimator lens 23 converts laser light 70 that has been emitted from laser emission end face 61 of optical fiber 60 and has spread for example to a parallel light beam. Light-collecting lens 24 light-collects laser light 70 converted to this parallel light beam to a given position. Laser light 70 is radiated toward a given process point of workpiece W through the nozzle. At this time, the distance between laser processing head 20 and workpiece W is adjusted using manipulator 30 for example so that the focal point of light-collecting lens 24 is positioned on or near the surface of workpiece W.

Wavelength selection mirror 25 is provided inside case 21 and also in the optical path of laser light 70 between collimator lens 23 and light-collecting lens 24. Wavelength selection mirror 25 is configured to transmit laser light 70 while reflecting light of a given wavelength different from that of laser light 70. Concretely, adjustment is made of the configuration of a wavelength selection filter (unillustrated) formed on the top surface of wavelength selection mirror 25, which provides a desired wavelength selectivity.

Transmission window 26, provided in order to introduce light from the outside to the inside of case 21, has cover glass 27 inserted into transmission window 26 to maintain airtightness inside case 21. Transmission window 26 is positioned where laser emission end face 61 of optical fiber 60 can be optically observed through wavelength selection mirror 25. In other words, the layout of optical fiber 60, wavelength selection mirror 25, and transmission window 26 is defined so that light that has been transmitted by transmission window 26 is reflected by wavelength selection mirror 25 and illuminates laser emission end face 61. Here, laser light 70 has been converted to a parallel light beam by collimator lens 23, and thus the distance between collimator lens 23 and light-collecting lens 24 (a section where laser light 70 is parallel) is subject to no substantial constraints, which facilitates disposing wavelength selection mirror 25 in the section.

Optical fiber inspection device 80 includes illumination light source 81 that emits light of a given wavelength different from that of laser light 70, optical observation device 82 for observing laser emission end face 61 of optical fiber 60 illuminated by light from illumination light source 81, light-guiding member 83, and light-branching member 84.

Note that optical fiber inspection device 80 is detached from laser processing head 20 for regular laser processing; is attached to laser processing head 20 to inspect optical fiber 60 (especially conditions of laser emission end face 61) for regular inspection for example. Illumination light source 81 and optical observation device 82 may be disposed as one device for example or as individual devices.

Connection is made between illumination light source 81 and transmission window 26 by light-guiding member 83. There is light-branching member 84 such as a half mirror disposed in the path of light-guiding member 83.

As described above, wavelength selection mirror 25 is configured to reflect light of a given wavelength different from that of laser light 70, and thus the light of the given wavelength different from that of laser light 70 emitted from illumination light source 81 goes toward wavelength selection mirror 25 through light-guiding member 83 and light-branching member 84, is reflected by wavelength selection mirror 25, and illuminates laser emission end face 61. Then, return light reflected by laser emission end face 61 is reflected by wavelength selection mirror 25, and is led to optical observation device 82, which allows laser emission end face 61 to be optically observed using optical observation device 82. Based on the observation results, conditions of laser emission end face 61 can be inspected, such as buildup of dust for example, burning of the end face, and damage to the end face.

As described hereinbefore, according to the embodiment, laser processing head 20 is provided with transmission window 26 and wavelength selection mirror 25 for optically observing laser emission end face 61 of optical fiber 60, which allows inspecting laser emission end face 61 of optical fiber 60 from the outside of laser processing head 20. In this way, as a result that laser emission end face 61 of optical fiber 60 is observed from transmission window 26 through wavelength selection mirror 25, conditions of laser emission end face 61 can be inspected in-situ. That is, inspection can be done in a state where an optical fiber is connected to the laser processing head with the layout of transmission window 26 and wavelength selection mirror 25 actually placed in laser processing head 20. Thus, the appropriate time for replacing optical fiber 60 can be determined for example. Besides, conditions of laser emission end face 61 can be inspected without the need of detaching optical fiber 60 from laser processing head 20, and thus the maintenance frequency of laser processing head 20 can be appropriately determined, which reduces costs for maintenance for example.

To use an optical fiber for light-guiding member 83, it is reasonable to provide an optical fiber port (unillustrated) instead of transmission window 26 and to connect an optical fiber. Besides, it is preferable that there is an antireflection film (unillustrated) provided that prevents reflection of illumination light from illumination light source 81 and return light from laser emission end face 61, on the inner and outer surfaces of cover glass 27 inserted into transmission window 26. Using an optical coherence tomography device as optical fiber inspection device 80 allows conditions of laser emission end face 61 to be observed in high resolution, which increases the inspection accuracy.

There may be a wavelength selection filter (unillustrated) provided that transmits illumination light from illumination light source 81 while cutting laser light 70, in contact with or near the surface of transmission window 26 or the optical fiber port close to case 21. Such a configuration significantly reduces the component of laser light 70 that enters optical observation device 82, which increases the observation accuracy.

### Second Exemplary Embodiment

FIG. 3 illustrates the main part of laser processing head 20a to which optical fiber 60 and optical fiber inspection device 80 according to the embodiment are attached.

The configuration shown in this embodiment is different from that shown in the first embodiment (refer to FIG. 2) in that detachable optical block 28 is attached to case 21. Optical block 28 has openings or transmission windows (unillustrated) at the upper and lower parts of optical block 28, between collimator lens 23 and light-collecting lens 24 in case 21 so as to transmit laser light 70 and light from illumination light source 81. There is transmission window 26 provided in the sidewall of this optical block 28, and there is wavelength selection mirror 25 provided inside optical block 28. Here, the material of optical block 28 is preferably same as that of case 21.

As described above, wavelength selection mirror 25 is configured to transmit laser light 70; however, wavelength selection mirror 25 having a transmittance of 100% is infeasible, and thus part of laser light 70 (e.g., 0. several percent) is reflected and is absorbed into case 21.

Meanwhile, laser processing demands a higher output power of laser light 70, where a loss of laser light 70 due to the above-described reflection needs to be suppressed. Besides, case 21 absorbs part of laser light 70, which increases the temperature of case 21 and thermally expands case 21. This may cause the layout of the optical components provided inside case 21 to be deviated from a given layout. Also, a temperature rise may speed up the deterioration of case 21, which shortens its service life.

Hence, as described in this embodiment, optical block 28 detachable from case 21 is provided, and wavelength selection mirror 25 and transmission window 26, which are components required for observing conditions of laser emission end face 61 of optical fiber 60, are provided in optical block 28. This structure can suppress a loss of laser light 70 by detaching optical block 28 for regular laser processing. Only for inspecting optical fiber 60, optical block 28 is attached to case 21, and conditions of laser emission end face 61 can be observed using optical fiber inspection device 80.

In the first and second embodiments, an optical fiber may be used as light-guiding member 83, for example, in order to observe laser emission end face 61 from transmission window 26, where light-guiding member 83 does not need to be used.

A wavelength selection filter may be provided on the undersurface of wavelength selection mirror 25. Alternatively, wavelength selection mirror 25 itself may be given the above-described wavelength selectivity.

The description is made that transmission window 26 is provided in the sidewall of case 21 in the first embodiment; in the sidewall of optical block 28, in the second embodiment. The position where transmission window 26 is provided is not limited to a sidewall. It is only required that transmission window 26 is provided at a position where the transmitted light of a given wavelength different from that of laser light 70 from illumination light source 81 is reflected by wavelength selection mirror 25 and illuminates laser emission end face 61 of optical fiber 60 directly or indirectly.

### Advantages

As described above, it is preferable that a detachable optical block is provided between the collimator lens and light-collecting lens in the case; the transmission window is provided in the optical block instead of the case; and the wavelength selection mirror is provided inside the optical block.

With this configuration, the laser emission end face can be observed without the need of detaching the optical fiber from the laser processing head, and a loss of laser light can be suppressed by detaching the optical block for regular laser processing.

### INDUSTRIAL APPLICABILITY

With a laser processing head, an optical fiber inspection device that inspects an optical fiber connected to the laser processing head, and an optical fiber inspection method by which an optical fiber connected to the laser processing head is inspected, conditions of the laser emission end face can be inspected without the need of detaching the optical fiber, and thus it is useful to apply them to a laser processing device that processes a large number of workpieces with high output power.

### REFERENCE MARKS IN THE DRAWINGS

10 laser processing device

20 laser processing head

20a laser processing head

21 case

22 connector

23 collimator lens

24 light-collecting lens

25 wavelength selection mirror

26 transmission window

27 cover glass

28 optical block

30 manipulator

40 control unit

50 laser oscillator

60 optical fiber

61 laser emission end face

70 laser light

80 optical fiber inspection device

81 illumination light source

82 optical observation device

83 light-guiding member

84 light-branching member

W workpiece

1. A laser processing head that is connected to an optical fiber and radiates laser light wave-guided by the optical fiber toward a workpiece, comprising:
a collimator lens that converts the laser light into a parallel light beam;
a light-collecting lens that collects the laser light converted into the parallel light beam;
a case that contains the collimator lens and the light-collecting lens;
a wavelength selection mirror that is provided in an optical path of the laser light between the collimator lens and the light-collecting lens and transmits the laser light, while reflecting light of a given wavelength different from a wavelength of the laser light; and
a transmission window provided at a position where the light of the given wavelength is transmitted and also where a laser emission end face of the optical fiber can be optically observed through the wavelength selection mirror.

2. The laser processing head of claim 1, further comprising an optical block that is detachably provided between the collimator lens and the light-collecting lens in the case, has a the transmission window in a sidewall of the optical block, and contains the wavelength selection mirror.

3. An optical fiber inspection device connected to the laser processing head of claim 1, comprising:
an illumination light source that illuminates the laser emission end face with the light of the given wavelength different from the wavelength of the laser light, from the transmission window through the wavelength selection mirror; and
an optical observation device that allows the laser emission end face illuminated by the illumination light source to be observed from the transmission window through the wavelength selection mirror.

4. An optical fiber inspection method by which the optical fiber connected to the laser processing head of claim 1 is inspected, comprising the steps of:
illuminating the laser emission end face with the light of the given wavelength different from the wavelength of the laser light, from the transmission window through the wavelength selection mirror;
optically observing the laser emission end face with the light of the given wavelength, from the transmission window through the wavelength selection mirror; and
inspecting conditions of the laser emission end face based on an observation result in the step of optically observing.
